(19) United States
(12) Patent Application Publication
(10) Pub. No.: US 2026/0008913 A1
(43) Pub. Date: Jan. 8, 2026

(54) OLEFIN POLYMERIZATION PROCESS COMPRISING THE USE OF AN ANTISTATIC COMPOSITION

(71) Applicant: Basell Poliolefine Italia S.r.l, Milano (IT)

(72) Inventors: Enrico Balestra, Ferrara (IT); Antonio Mazzucco, Ferrara (IT); Pier Luigi Di Federico, Ferrara (IT); Roberto Pantaleoni, Ferrara (IT); Paolo Capisani, Ferrara (IT)

(73) Assignee: Basell Poliolefine Italia S.r.l, Milano (IT)

(21) Appl. No.: 19/128,665

(22) PCT Filed: Nov. 16, 2023
(86) PCT No.: PCT/EP2023/082142

§ 371 Date: May 9, 2025

(30) Foreign Application Priority Data
Nov. 18, 2022 (EP) 22208336.2

(51) Int. Cl. C08L 23/12; B01J 8/08; B01J 8/18

(52) U.S. Cl. CPC C08L 23/12; B01J 8/085; B01J 8/087; B01J 8/1827; B01J 8/1836; B01J 2208/00256; B01J 2208/00849

(57) ABSTRACT

A process for preparing polyolefins including the step of:
polymerizing an olefin in the liquid phase in the presence of a polymerization catalyst and an antistatic composition, thereby forming a polymer slurry,
wherein the polymer slurry is conveyed in a transfer line including a horizontal section and a series of vertical sections connected by bent sections, with the antistatic composition injected in the first portion of the first section of the series of vertical sections.

### FIELD OF THE INVENTION

In general, the present disclosure relates to the field of chemistry. More specifically, the present disclosure relates to polymer chemistry. In particular, the present disclosure relates to a process for preparing polyolefins including the step of injecting an antistatic composition and a plant for carrying out the process including a slurry polymerization reactor.

### BACKGROUND OF THE INVENTION

In some instances, antistatic agents are used in processes for the polymerization of olefins to avoid electrostatic charging, thereby reducing wall sheeting and formation of polymer agglomerates in the polymerization reactor or downstream equipment. In some instances, the downstream equipment includes degassing and recovery vessels. In some instances, antistatic agents include antifouling agents, polymerization process aids, activity inhibitors, productivity inhibitors or kinetic modifiers. In some instances, antistatic agents are made from or containing compounds having polar functional groups. In some instances, the polar functional groups are selected from the group consisting of acid or ester groups, amine or amide groups or hydroxyl or ether groups. In some instances, the compounds are selected from the group consisting of polysulfone copolymers, polymeric polyamines, polyalcohols, hydroxyesters of polyalcohols, salts of alkylarylsulfonic acids, polysiloxanes, alkoxyamines, and polyglycol ethers.

In some instances, antistatic agents negatively impact the activity of olefin polymerization catalysts. In some instances, antistatic agents have limited use in preparing polyolefins for food, beverage and medical packaging applications.

In some instances, the slurry polymerization of liquid propylene carried out in a loop reactor is followed by a gas-phase polymerization carried out in fluidized-bed reactor. In some instances, antistatic composition is injected in the process, for example, downstream the loop reactor or in the gas-phase reactor.

In some instances, the polymer slurry is continuously recirculated in the loop reactor, but a fraction of the polymer slurry is continuously discharged to a transfer line having a heatable pipe. In some instances, the discharge into the transfer line involves a pressure drop, thereby permitting evaporation of liquid propylene by heat distributed along a length of the pipe at lower pressure than that inside the loop reactor. In some instances, a turbulent flow made from or containing polymer and gaseous monomers is generated. In some instances and depending on the size of the plant and other factors, the pipe of the transfer line is bent one or more times.

In some instances, improper selection of the injection point causes a partial deposit of the antistatic composition in the transfer line. In some instances, an inefficient dispersion results in depositing of a viscous layer of antistatic composition on the walls of the transfer line and reacting of the antistatic composition with co-catalyst. In some instances, polymer fines become present in the liquid slurry, thereby fouling and affecting adversely the operability of downstream equipment.

### SUMMARY OF THE INVENTION

In a general embodiment, the present disclosure provides a process for preparing polyolefins including the steps of:
(I) polymerizing an olefin in the liquid phase in the presence of a polymerization catalyst and an antistatic composition made from or containing
   (a) from 0.5 to 50% by weight of a compound of formula R—OH, wherein R represents hydrogen or a linear or branched, saturated alkyl group, having from 1 to 15 carbon atoms, based upon the total weight of the antistatic composition; and
   (b) from 50 to 99.5% by weight of an oligomeric or polymeric organic compound, having one or more terminal hydroxyl groups and a viscosity at 40° C. of at least 20 mm²/sec (DIN 51562), based upon the total weight of the antistatic composition, thereby forming a polymer slurry;
(II) withdrawing a part of the polymer slurry;
(III) advancing the part along a path including a horizontal section and a series of vertical sections connected by bent sections, with the first section of the series of vertical sections including a first portion not subjected to heating and a second portion subjected to heating, and the other vertical sections also including portions subjected to heating, thereby, at the end of the path, converting the polymer slurry into a two-phase, solid-gas stream made from or containing polymer particles and gaseous monomers;
(IV) adding the antistatic composition to the polymer slurry in the first portion not subjected to heating of the first section of the series of vertical sections; and
(V) separating the two-phase, solid-gas stream.

In some embodiments, the present disclosure provides a plant for preparing polyolefins including at least a slurry polymerization reactor, a transfer line for the polymer slurry formed in the reactor, an apparatus for mixing and injecting an antistatic composition in the transfer line, and a solid-gas separation apparatus connected to the transfer line at the end thereof;
wherein the transfer line has a pipe having a horizontal section and a series of vertical sections con-nected by bent sections, with the first section of the vertical sections having a first portion not equipped for heating and a second portion equipped for heating, and the other vertical sections also having portions equipped for heating;
wherein the antistatic composition is injected into the first portion not equipped for heating of the first section of the series of vertical sections.

### BRIEF DESCRIPTION OF THE DRAWINGS

FIG. 1 is a schematic of a set-up of a polymerization process including a loop-reactor and a gas-phase reactor for carrying out a process for preparing polyolefins.

FIG. 2 is a schematic of an apparatus for mixing and injecting an antistatic composition for use in the process of FIG. 1.

FIG. 3 is a schematic of a set-up of a polymerization process including two loop-reactors for carrying out a process for preparing polyolefins.

### DETAILED DESCRIPTION OF THE INVENTION

In some embodiments, the present disclosure provides a process for the polymerization of olefins. In some embodiments, the olefins are 1-olefins, that is, hydrocarbons having terminal double bonds, without being restricted thereto. In some embodiments, the 1-olefins are selected from the group consisting of linear or branched 1-alkenes having from 2 to 12 carbon atoms, conjugated and non-conjugated dienes, and vinyl-aromatic compounds. In some embodiments, the linear 1-alkenes have from 2 to 10 carbon atoms. In some embodiments, the linear 1-alkenes are selected from the group consisting of ethylene, propylene, 1-butene, 1-pentene, 1-hexene, 1-heptene, 1-octene, and 1-decene. In some embodiments, the branched 1-alkenes have from 2 to 10 carbon atoms. In some embodiments, the branched 1-alkene is 4-methyl-1-pentene. In some embodiments, the dienes are selected from the group consisting of 1,3-butadiene, 1,4-hexadiene, and 1,7-octadiene. In some embodiments, the vinyl-aromatic compounds are styrene or substituted styrene. In some embodiments, mixtures of various 1-olefins are polymerized. In some embodiments, the olefins have the double bond as part of a cyclic structure. In some embodiments, the cyclic structure has one or more ring systems. In some embodiments, the olefins, including a cyclic structure, are selected from the group consisting of cyclopentene, norbornene, tetracyclododecene, methylnorbornene, o 5-ethylidene-2-norbornene, norbornadiene, and ethylnorbornadiene. In some embodiments, mixtures of two or more olefins are polymerized.

In some embodiments, the process is for the homopolymerization or copolymerization of ethylene or for the homopolymerization or copolymerization of propylene. In some embodiments, comonomers for use in ethylene polymerization are 1-alkenes having from 3 to 8 carbon atoms. In some embodiments, the 1-alkenes are selected from the group consisting of 1-butene, 1-pentene, 1-hexene, and. 1-octene. In some embodiments, the 1-alkenes are in amount of up to 20 wt. %, alternatively from 0.01 wt. % to 15 wt. %, alternatively from 0.05 wt. % to 12 wt. %. In some embodiments, comonomers for use in propylene polymerization are selected from the group consisting of ethylene, 1 butene, and. 1-hexene. In some embodiments, the comonomers are in amount of up to 40 wt. %, alternatively from 0.5 wt. % to 35 wt. %.

In some embodiments, the olefin polymers are broad molecular weight olefin polymers. In some embodiments, the olefin polymers are multimodal olefin polymers. As used herein, the term “multimodal” refers to the modality of the molecular weight distribution. In some embodiments, multimodal includes bimodal. In some embodiments, the polymers are obtained from polymerizing olefins in a cascade of two or more polymerization reactors or in different zones of a multizone reactor under different reaction conditions. The “modality” indicates how many different polymerization conditions were utilized to prepare the polyolefin, independently whether this modality of the molecular weight distribution is recognizable as separated maxima in a gel permeation chromatography (GPC) curve. In some embodiments, the olefin polymer has a comonomer distribution. In some embodiments, the average comonomer content of polymer chains with a higher molecular weight is higher than the average comonomer content of polymer chains with a lower molecular weight. In some embodiments, identical or similar reaction conditions are used in the polymerization reactors of the reaction cascade, thereby preparing narrow molecular weight or monomodal olefin polymers.

In some embodiments, the polymerization of olefins is carried out using olefin polymerization catalysts. In some embodiments, the polymerization is carried out using titanium-based Ziegler-Natta-catalysts, Phillips catalysts based on chromium oxide, or single-site catalysts. As used herein, the term “single-site catalysts” refers to catalysts based on chemically uniform transition metal coordination compounds. In some embodiments, mixtures of two or more of these catalysts are used for the polymerization of olefins. In some embodiments, the mixed catalysts are referred to as hybrid catalysts.

In some embodiments, catalysts for the process are Ziegler-Natta catalysts made from or containing:
(i) a solid catalyst component made from or containing Mg, Ti, a halogen and an electron donor compound (internal donor),
(ii) an alkylaluminum compound, and
(iii) optionally, an electron-donor compound (external donor).

In some embodiments, component (i) is prepared by contacting a magnesium halide, a titanium compound having at least a Ti-halogen bond, and optionally an electron donor compound. In some embodiments, the magnesium halide is MgCl₂ in active form. In some embodiments, the titanium compounds are TiCl₄ or TiCl₃. In some embodiments, Ti-haloalcoholates of formula Ti(OR)_{n-y}X_{y}, where n is the valence of titanium, y is a number between 1 and n-1, X is halogen, and R is a hydrocarbon radical having from 1 to 10 carbon atoms, are used.

In some embodiments, electron donor compounds for preparing Ziegler type catalysts are selected from the group consisting of alcohols, glycols, esters, ketones, amines, amides, nitriles, alkoxysilanes and aliphatic ethers. In some embodiments, the electron donor compounds are used alone. In some embodiments, the electron donor compounds are used in mixtures with other electron donor compounds.

In some embodiments, other solid catalyst components are based on a chromium oxide supported on a refractory oxide and activated by a heat treatment. In some embodiments, the refractory oxide is silica. In some embodiments, the catalysts consist of chromium (VI) trioxide chemically fixed on silica gel. In some embodiments, these catalysts are produced under oxidizing conditions by heating the silica gels that have been doped with chromium (III) salts (precursor or precatalyst). In some embodiments and during this heat treatment, the chromium (III) oxidizes to chromium (VI), the chromium (VI) is fixed and the silica gel hydroxyl group is eliminated as water.

In some embodiments, the other solid catalyst components are single-site catalysts supported on a carrier. In some embodiments, the single-site catalysts are metallocene catalysts made from or containing:
at least a transition metal compound containing at least one n bond; and
at least a cocatalyst selected from an alumoxane or a compound able to form an alkylmetallocene cation.

In some embodiments, the catalyst includes an alkylaluminum compound and the molar ratio of component (a) to alkylaluminum compound introduced into the polymerization reactor is from 0.05 to 3, alternatively from 0.1 to 2, alternatively from 0.5 to 1. In some embodiments, the catalyst is a Ziegler Natta catalyst.

In some embodiments, the catalysts are optionally subjected to prepolymerization before being fed to the polymerization reactor. In some embodiments, the prepolymerization occurs in a loop reactor. In some embodiments, the prepolymerization of the catalyst system is carried out in a range of from 0° C. to 60° C.

In some embodiments, the process is carried out in a polymerization plant including one or more liquid-phase polymerization reactors and optionally one or more gas-phase polymerization reactors. In some embodiments, the liquid-phase reactors are selected from the group consisting of loop reactors and continuously stirred tank reactors (CSTR). In some embodiments, the gas-phase reactors are fluidized bed reactors. In some embodiments, the process is carried in two or more cascade reactors, giving rise to a sequential multistage polymerization process. In some embodiments, a liquid-phase loop reactor is used to prepare a first polymer component, which is successively fed to a gas-phase reactor for preparing a second polymer component. In some embodiments, the resulting polymer is an olefin polymer having a multi-modal molecular weight distribution. In some embodiments, the resulting polymer is an olefin copolymer made from or containing two or more components having a different comonomer content.

In some embodiments, the polymerization process includes a gas-phase polymerization, that is, the solid polymers are obtained from a gas-phase of the monomer or the monomers. In some embodiments, the gas-phase polymerizations are carried out at pressures of from 0.1 to 20 MPa, alternatively from 0.5 to 10 MPa, alternatively from 1.0 to 5 MPa. In some embodiments, the gas-phase polymerizations are carried out at polymerization temperatures from 40 to 150° C., alternatively from 65 to 125° C.

In some embodiments, the gas-phase polymerization reactors are horizontally or vertically stirred reactor, fluidized bed gas-phase reactors or multizone circulating reactors.

Fluidized-bed polymerization reactors are reactors in which the polymerization takes place in a bed of polymer particles which is maintained in a fluidized state by feeding in gas at the lower end of a reactor and taking off the gas again at the reactor's upper end. In some embodiments, the gas is fed below a gas distribution grid having the function of dispensing the gas flow. The reactor gas is then returned to the lower end to the reactor via a recycle line equipped with a compressor and a heat exchanger. In some embodiments, the circulated reactor gas is a mixture of the olefins to be polymerized, inert gases, and optionally a molecular weight regulator. In some embodiments, the inert gases are selected from the group consisting of nitrogen and lower alkanes. In some embodiments, the lower alkanes are selected from the group consisting of ethane, propane, butane, pentane, and hexane. In some embodiments, the molecular weight regulator is hydrogen. In some embodiments, nitrogen or propane is used as inert gas. In some embodiments, nitrogen or propane is used as inert gas, in combination with further lower alkanes. In some embodiments, the velocity of the reactor gas fluidizes the mixed bed of finely divided polymer present in the tube serving as polymerization zone and removes the heat of polymerization. In some embodiments, the polymerization is carried out in a condensed or super-condensed mode, in which part of the circulating reaction gas is cooled to below the dew point and returned to the reactor separately as a liquid and a gas-phase or together as a two-phase mixture, thereby using the enthalpy of vaporization for cooling the reaction gas.

In some embodiments, the polymer slurry withdrawn from the slurry polymerization step advances along a path including a horizontal section and a series of vertical sections connected by bent sections. In some embodiments and depending on the size of the plant and other factors, the path of the polymer slurry includes from 1 to 13 vertical sections connected by bent sections, alternatively from 3 to 9 vertical sections.

In some embodiments, the first vertical section of the path of the polymer slurry includes a first portion not subjected to heating and a second portion subjected to heating, and the other vertical sections downstream the first vertical section also include portions subjected to heating, thereby, at the end of the path, the polymer slurry is converted into a two-phase, solid-gas stream made from or containing polymer particles and gaseous monomers, which is separated in a solid-gas separation step.

In some embodiments, the antistatic composition is added to the polymer slurry in the first portion not subjected to heating of the first section of the series of vertical sections.

In some embodiments, the first portion not subjected to heating of the first section of the series of vertical sections is shorter than the second portion subjected to heating of the first section of the series of vertical sections. In some embodiments, the first portion not subjected to heating is equal to or less than ⅓ of the length of the second portion subjected to heating of the first vertical section.

In some embodiments, the process for preparing polyolefins includes a step of feeding the polymer particles separated in the solid-gas separation step to a gas-phase polymerization step to be subjected to further polymerization.

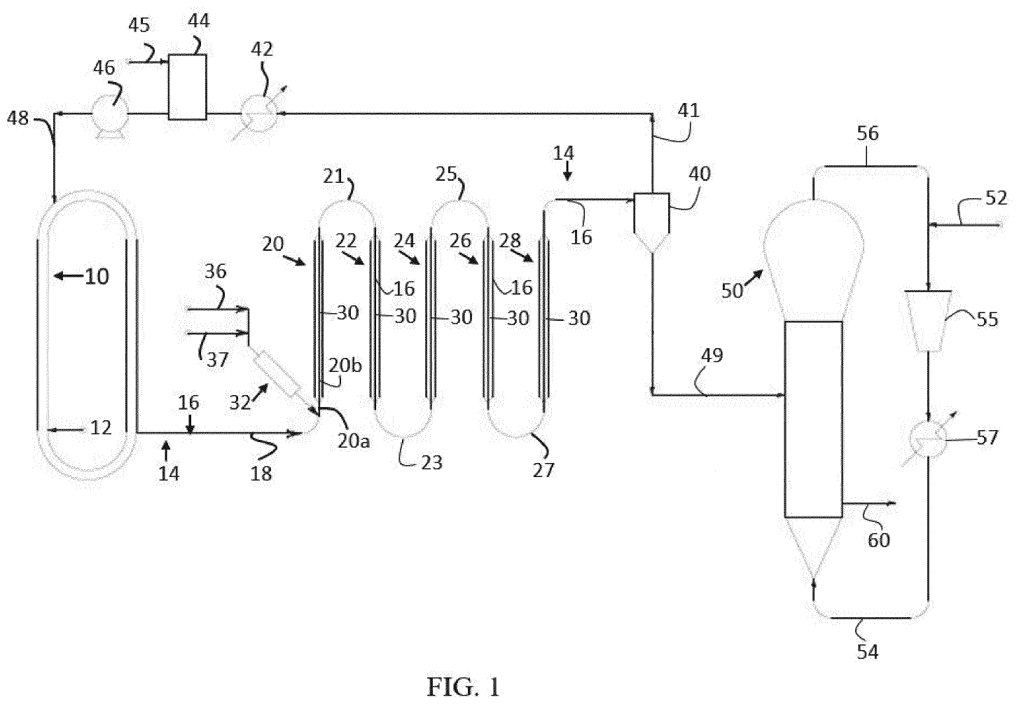

FIG. 1 is a schematic showing a cascade polymerization reactor. FIG. 1 is illustrative and not limiting of the scope of the disclosure.

In some embodiments, the slurry polymerization of liquid propylene is carried out in a loop reactor 10. In some embodiments, catalyst components, co-catalyst, and propylene and optionally comonomers are introduced into the loop reactor, as shown by arrow 12. In some embodiments, a Ziegler/Natta catalyst is made from or containing a solid component supported on active MgCl₂. In some embodiments, the solid component is fed as such or in a pre-polymerized form.

In some embodiments, loop reactor 10 is the first polymerization reactor of the process. In some embodiments, other reactor(s) are upstream reactor 10. In some embodiments, reactor 10 receives, from line 12, a polymer produced in other upstream reactor(s) or a prepolymer and/or a polymerization catalyst or catalyst component. For simplicity, feed lines for catalyst, monomer, molecular weight regulator and other possible ingredients are not shown.

Most of the polymer slurry is continuously recirculated in the loop reactor 10. A fraction of the polymer slurry is continuously discharged to a transfer line 14, which is connected to a flash chamber 40. The transfer line 14 consists of a pipe 16 including a horizontal section 18 and a series of vertical sections 20, 22, 24, 26, 28 connected by bent sections 21, 23, 25, 27. The vertical sections of pipe 16 are equipped with heating apparatus 30. In some embodiments, the heating apparatuses are steam jackets. In some embodiments, the horizontal section 18 is equipped for heating. In some embodiments, the horizontal section 18 is not equipped for heating.

In some embodiments, the first vertical section 20 of the series of vertical sections has a first portion 20a not equipped for heating, and a second portion 20b equipped with heating apparatus 30. In some embodiments, the first portion 20a is shorter than the second section 20b. In some embodiments, the first portion 20a is equal to or less than ⅓ of the length of the second portion 20b of the first vertical section 20.

FIG. 1 shows a series of 5 vertical sections for the pipe 16. In some embodiments and depending on the size of the plant and other factors, pipe 16 has from 1 to 12 vertical sections connected by bent sections, alternatively from 3 to 9 vertical sections.

In some embodiments, an antistatic composition is injected in the first portion 20a of the first vertical section 20 of pipe 16.

In some embodiments, the antistatic composition is made from or containing:
(a) from 0.5 to 50% by weight of a compound of formula R—OH, wherein R represents hydrogen or a linear or branched, saturated alkyl group having from 1 to 15 carbon atoms, based upon the total weight of the antistatic composition; and
(b) from 50 to 99.5% by weight of an oligomeric or polymeric organic compound, having one or more terminal hydroxyl groups and a viscosity at 40° C. of at least 20 mm²/sec (DIN 51562), based upon the total weight of the antistatic composition.

In some embodiments, the compound (a) of formula R—OH is water. In some embodiments, the compound (a) of formula R—OH is an alcohol selected from the group consisting of methanol, ethanol, 1-propanol, 1-butanol, 1-pentanol, 1-hexanol, 1-heptanol, 1-octanol, 1-nonanol, 1-decanol, undecan-1-ol, dodecan-1-ol, tridecan-1-ol, 1-tetradecanol, pentadecan-1-ol, isobutanol, isoamyl alcohol, 2-methyl-1-propanol, phenethyl alcohol, tryptophol, isopropanol, 2-butanol, 2-pentanol, 2-hexanol, 2-heptanol, cyclohexanol, tert-butyl alcohol, tert-amyl alcohol, 2-methyl-2-pentanol, 2-methylhexan-2-ol, 2-methylheptan-2-ol, 3-methyl-3-pentanol and 3-methyloctan-3-ol.

In some embodiments, the oligomeric or polymeric organic compound (b) has a viscosity at 40° C. (DIN 51562) of 30-2000 mm²/sec, alternatively of 50-1500 mm²/sec, alternatively of 100-1000 mm²/sec, alternatively of 150-500 mm²/sec, alternatively of 200-400 mm²/sec, alternatively of 250-300 mm²/sec, alternatively of 260-285 mm²/sec. In some embodiments, the viscosity at 40° C. (DIN 51562) of the oligomeric or polymeric organic compound (b) is in the range of 260 to 285 mm²/sec.

In some embodiments, the oligomeric or polymeric organic compound (b) is selected from the group consisting of alcohols, polyethers, polyalcohols, hydroxyesters of polyalcohols, polyglycol ethers, polyglycol esters and derivatives thereof.

In some embodiments, the oligomeric or polymeric organic compound (b) is a polyether. In some embodiments, the oligomeric or polymeric organic compound (b) is an alkylene-oxide-derived polymer made from or containing on average from 10 to 200 repeating units —(CH₂—CHR—O)—, with R being hydrogen or an alkyl group having from 1 to 6 carbon atoms.

In some embodiments, the terminal groups of the alkylene-oxide-derived polymer are —OH groups.

In some embodiments, the alkylene-oxide-derived polymer is a random copolymer of ethylene oxide and of other alkylene oxides, wherein the repeating units —(CH₂—CH₂—O)ₙ— derived from ethylene oxide to repeating units —(CH₂—CHR′—O)ₘ— derived from the other alkylene oxides, with R′ being an alkyl group having from 1 to 6 carbon atoms, are present in a ratio n: m in the range of from 6:1 to 1:1, alternatively from 5:1 to 1.5:1, alternatively from 4:1 to 2:1.

In some embodiments, the alkylene-oxide-derived polymer is a linear polymer of formula (I)

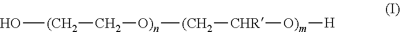

wherein R′ is an alkyl group having from 1 to 6 carbon atoms, alternatively an alkyl group having from 1 to 3 carbon atoms, alternatively a methyl group; n is in the range of from 10 to 180, alternatively from 20 to 100, alternatively from 30 to 50; m is in the range of from 2 to 120, alternatively from 10 to 80, alternatively from 10 to 40; and n and m denoting the average number of repeating units.

In some embodiments, alkylene-oxide-derived polymer is a random copolymer of ethylene oxide and propylene oxide.

In some embodiments, the ethylene oxide/propylene oxide copolymer is a linear ethylene oxide/propylene oxide copolymer of formula (II)

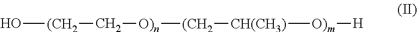

wherein n is in the range of from 10 to 180, alternatively from 20 to 100, alternatively from 30 to 50, and m is in the range of from 2 to 120, alternatively from 10 to 80, alternatively from 10 to 40.

In some embodiments, alkylene-oxide-derived polymers are prepared by reacting ethylene oxide and the other alkylene oxides with polyhydric alcohols. In some embodiments, the other alkylene oxide is propylene oxide. In some embodiments, the polyhydric alcohols are selected from the group consisting of diols, triols, and polyols. In some embodiments, the diol is ethylene glycol. In some embodiments, the triol is glycerol. In some embodiments, the polyol is pentaerythritol. In some embodiments, the reaction with diols results in linear polymers.

In some embodiments, the oligomeric or polymeric organic compound (b) is water-soluble. As used herein, the term “water-soluble” refers to soluble in water at room temperature, that is, at about 23° C.

In some embodiments, the amount of antistatic composition introduced into the polymerization reactor is from 1 to 5000 ppm per weight, alternatively from 10 to 3000 ppm per weight, alternatively from 50 to 1000 ppm per weight, referring to the weight of the prepared polyolefin.

In some embodiments, the amount of component (a) introduced into the polymerization reactor is from 1 to 70 ppm per weight, alternatively from 1 to 50 ppm per weight, alternatively from 2 to 40 ppm per weight, alternatively from 2 to 30 ppm per weight, alternatively from 3 to 30 ppm per weight, alternatively from 3 to 20 ppm per weight, referring to the weight of the prepared polyolefin.

In some embodiments, the amount of component (a) in the antistatic composition introduced into the polymerization reactor is from 0.5 to 50% by weight, alternatively from 3 to 30% by weight, alternatively from 5 to 15% by weight, with respect to the total weight of antistatic composition.

In some embodiments, the amount of component (b) in the antistatic composition introduced into the polymerization reactor is from 50 to 99.5% by weight, alternatively from 70 to 97% by weight, alternatively from 85 to 95% by weight, with respect to the total weight of antistatic composition.

In some embodiments, the antistatic composition is provided to the polymerization process as a pre-prepared mixture. In some embodiments, components (a) and (b) of the antistatic composition are separately provided to the polymerization process.

In some embodiments, the antistatic composition or individual components thereof are fed to the polymerization reactor in a flow of saturated or unsaturated hydrocarbon, having from 2 to 6 carbon atoms. In some embodiments, the hydrocarbon is a monomer or an alkane. In some embodiments, the monomer is propylene. In some embodiments, the alkane is propane. In some embodiments, the monomer and the alkane are in liquid or gas form.

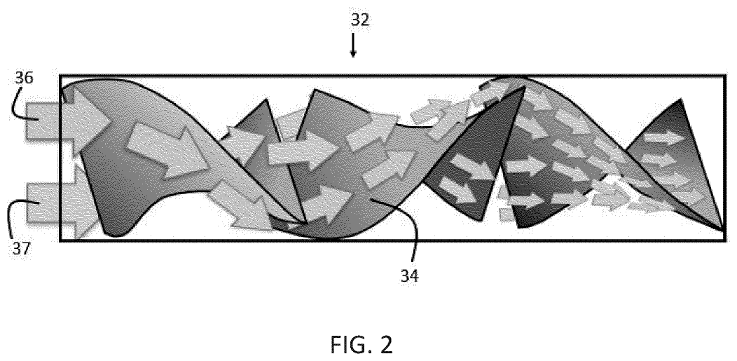

In some embodiments, the antistatic composition is injected by apparatus 32. In some embodiments, the components of the antistatic composition are mixed in apparatus 32. FIG. 2 shows apparatus 32.

In some embodiments, apparatus 32 is a static mixer in which the antistatic composition, or the components thereof, and the hydrocarbon are mixed, thereby creating an emulsion of small droplets of the antistatic agent dispersed in the hydrocarbon continuous phase.

In some embodiments and in static mixer 32, the energy for mixing comes from a loss in pressure as fluids flow through the static mixer. In some embodiments, the mixer elements 34 are contained in a cylindrical housing. In some embodiments, the housing is made of stainless steel.

With reference to the figures, arrow 36 designates the feed of the antistatic composition, in which components (a) and (b) have been pre-mixed, and arrow 37 designates the feed of hydrocarbon.

Upon discharge from reactor 10, the polymer slurry is depressurized and heated in the jacketed portions of the series of vertical sections 20, 22, 24, 26, 28. In some embodiments, the horizontal section 18 is equipped for heating and heating of the polymer slurry is initiated in the horizontal section. In some embodiments and under these conditions, liquid propylene is evaporated and a turbulent flow is generated inside pipe 16.

At the outlet of jacketed pipe 16, a two-phase, solid-gas stream, containing evaporated monomers and polymer particles, is conveyed to flash chamber 40, where the pressure is decreased. The particles of solid polymer fall by gravity towards the bottom of flash chamber 40 while the gaseous monomers flow upwards to the top of chamber 40. In some embodiments, the gaseous monomers are collected and sent via line 41 to a monomer recovery section having a cooler 42, a monomer make-up unit 44 and a compressor 46. Fresh propylene supplied as shown by arrow 45 and recycled propylene from flash chamber 40 are fed via line 48 to loop reactor 10 for continued polymerization.

Propylene polymer discharged from flash tank 40 is transferred via line 49 to a fluidized-bed gas-phase reactor 50, where a propylene copolymer is generated on the homo-PP particles coming from the loop reactor 10. In some embodiments, the propylene copolymer is an ethylene propylene elastomeric copolymer. In some embodiments, reactor 50 is operated at a pressure between 10 and 30 bar and at a temperature between 50 and 110° C. Fresh monomers 52 are fed to reactor 50 through line 54. Unreacted monomers are recycled through line 56 equipped with a compressor 55 and a heat exchanger 57 placed downstream the compressor 55. In some embodiments, a heterophasic copolymer or impact PP is discharged from line 40. In some embodiments, the product is the end product of the polymerization process and transferred to the finishing section of the plant. In some embodiments, the product is transferred to a second gas-phase reactor (not shown) for enrichment in the copolymer fraction.

In some embodiments, different or identical polymerization processes are connected in series, thereby forming a polymerization cascade. In some embodiments, a parallel arrangement of reactors uses two or more different or identical processes.

In some embodiments, the polymerization processes in the gas-phase reactors are carried out in the presence of an alkane having from 3 to 5 carbon atoms as polymerization diluent, for example, in the presence of propane.

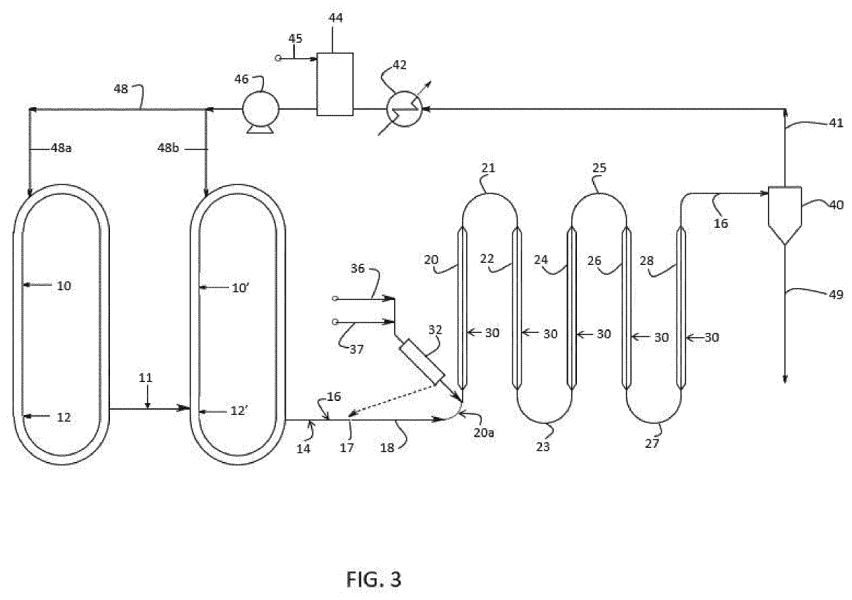

FIG. 3 is a schematic of a polymerization process including two liquid-phase loop reactors. FIG. 3 is illustrative and does not limit the scope of the disclosure.

In some embodiments, the slurry polymerization of liquid propylene is carried out in a first loop reactor 10 and in a second loop reactor 10′. In some embodiments and as described in connection to FIG. 1, catalyst components, co-catalyst, and propylene and optionally comonomers are introduced into the loop reactor, as shown by arrow 12. In some embodiments, a Ziegler/Natta catalyst is made from or containing a solid component supported on active MgCl₂. In some embodiments, the solid component is fed as such or in a pre-polymerized form.

In some embodiments, second loop reactor 10′ receives, from line 11, the polymer produced in upstream reactor 10 and optionally additional catalyst components, co-catalyst, comonomers and propylene are introduced in the second loop reactor, as shown by arrow 12′.

Most of the polymer slurry is continuously recirculated in the loop reactors. A fraction of the polymer slurry is continuously discharged from reactor 10′ to transfer line 14, which is connected to a flash chamber 40, as described for FIG. 1. The components of transfer line 14 include pipe 16 including a horizontal section 18 and a series of vertical sections 20, 22, 24, 26, 28 connected by bent sections 21, 23, 25, 27 and up to the flash chamber 40. The polymer discharged from flash chamber 40 is transferred via line 49 to a finishing section (not shown).

Fresh propylene, supplied as shown by arrow 45, and recycled propylene from flash chamber 40 are fed via line 48 to the loop reactors 10, 10′ via two lines 48a, 48b, for continued polymerization.

In some embodiments, the fouling in the pipe that transfers the polymer slurry from the discharge of the slurry loop reactor to the apparatus for the separation of the polymer particles from the evaporated unreacted monomers and gases is prevented or minimized with a flash chamber, a gas/solid filter, or both.

In some embodiments, the process prevents or minimizes the tendency of the olefin polymer particles to stick to the walls of gas-phase reactors.

### EXAMPLES

The following examples are given to be illustrative without limiting the scope of this disclosure in any manner whatsoever.

### Example 1

### Preparation of the Ziegler-Natta Solid Catalyst Component

A solid catalyst component was prepared with the procedure described in Example 1 of European Patent No. EP 0 728 769 B.

### Catalyst Activation and Prepolymerization

Before introducing the solid catalyst component into the polymerization reactors, the solid catalyst component was contacted with aluminum-triethyl (TEAL) and with cyclohexylmethyldimethoxysilane (donor C) under the conditions reported in Table 1.

The activated catalyst discharged from the activation vessel was continuously fed, together with liquid propylene, to a prepolymerization loop reactor operated at the conditions reported in Table 1.

### Polymerization

The polymerization run was conducted in continuous mode in two loop reactors operated in series, according to the set-up of FIG. 3, and at the same operating conditions. The prepolymerized catalyst was discharged from the prepolymerization reactor and was continuously fed to the liquid phase loop reactor 10. A propylene homopolymer was prepared in the liquid loop reactors. Liquid propylene was continuously fed to the loop reactors 10, 10′. Make-up propylene and hydrogen as molecular weight regulator were fed to the loop reactors 10, 10′ via lines 48a, 48b. A polypropylene slurry was discharged from the loop reactors 10, 10′, and allowed to continuously flow through transfer line 14 including a pipe 16 having a horizontal section 18 and a series of vertical sections 20, 22, 24, 26 and 28, each externally heated by steam jackets 30 in which hot steam was circulated.

An antistatic composition made from or containing 7% wt of water and 93% wt of Polyglykol PE-K 270 was fed by static mixer 32 in the first portion 20a not equipped for heating of the first vertical section 20 of pipe 16. Polyglykol PE-K 270 was commercially available from Clariant. The flow rate of the antistatic composition feed was to provide the polymer with an amount of antistatic of 440 ppm (wt).

After the addition of the antistatic composition, the polymer slurry entered the steam jacketed portion 30 of section 20 of pipe 16, and then in the other sections 22, 24, 26 and 28, also equipped with jackets 30, wherein the slurry was heated up to reach a temperature of 75° C. with consequent evaporation of the liquid phase. Successively, the stream of polypropylene and evaporated propylene obtained at the outlet of the pipe 16 was sent to a flash tank 40, where the evaporated monomer was separated from the polymer particles. The tangential entry of the above stream ensured a gas/solid separation by centrifugal effect. The flash tank 40 was operated at the pressure of 18 bar. The particles of solid polymer fell by gravity towards the bottom of the tank, while the gaseous phase exiting from the top was sent to the monomer recovery section. Polypropylene particles were discharged from the bottom of flash tank 40 and conveyed to the downstream finishing section.

The temperature inside the pipe 16 downstream the injection of the antistatic composition was constantly controlled in cascade with the pressure of the steam supplied to the jacketed portions of the pipe, thereby detecting whether (a) the heat exchange at the jacketed portions of the pipe was effective or (b) fouling inside pipe 16. An insulation effect and higher steam pressure would have suggested the occurrence of fouling. It is believed that higher steam supply temperature would be used to evaporate the liquid phase.

In Example 1, no insulation effect was detected as the steam supply pressure indicated a standard operating value, showing that no fouling occurred, showing the antistatic composition was effective, and ensuring stable operation of the plant for the duration of the trial.

### Example 2C (Comparative)

Example 1 was repeated with the difference that the same antistatic agent was injected into the transfer line 14, at the beginning of the horizontal section 18, at the point designated with 17. The antistatic effect was lower, as shown by a much higher pressure of the steam supplied to the jackets of pipes 30 at similar operating conditions in terms of production rate, antistatic feed flow rate and controlled temperature of the process gas separated in the flash drum, as reported in Table 1 below. The higher pressure indicated the formation of an insulation layer inside the pipe 16.

TABLE 1

| | | |
|---|---|---|
| Example | 1 | 2C |

Precontact

| | | |
|---|---|---|
| Temperature (° C.) | 15 | 15 |
| Residence time (min) | 14 | 15 |
| TEAL/catalyst (g/g) | 5.4 | 5.3 |
| TEAL/donor ratio (g/g) | 90 | 85 |

Prepolymerization

| | | |
|---|---|---|
| Temperature (° C.) | 20 | 20 |
| Residence time (min) | 7.5 | 7.5 |

Loop reactor in liquid phase - propylene homopolymerization

| | | |
|---|---|---|
| Production rate (t/h) | 21.2 | 20.4 |
| Temperature (° C.) | 74 | 74 |
| Pressure (barg) | 39.5 | 39 |
| Residence time (min) | 72 | 64 |

Loop reactor slurry discharge line and flash tank

| | | |
|---|---|---|
| Temperature at flash tank (° C.) | 75 | 76 |
| Pressure of steam supply (barg) | 0.13 | 0.90 |
| Antistatic amount (ppm wt) | 440 | 350 |

What is claimed is:

1. A process for preparing polyolefins comprising the steps of:
(I) polymerizing an olefin in the liquid phase in the presence of a polymerization catalyst and an antistatic composition comprising
(a) from 0.5 to 50% by weight of a compound of formula R—OH, wherein R represents hydrogen or a linear or branched, saturated alkyl group having from 1 to 15 carbon atoms, based upon the total weight of the antistatic composition; and
(b) from 50 to 99.5% by weight of an oligomeric or polymeric organic compound, having one or more terminal hydroxyl groups and a viscosity at 40° C. of at least 20 mm²/sec (DIN 51562), based upon the total weight of the antistatic composition, thereby forming a polymer slurry;
(II) withdrawing a part of the polymer slurry;
(III) advancing the part along a path comprising a horizontal section and a series of vertical sections connected by bent sections, with the first section of the series of vertical sections comprising a first portion not subjected to heating and a second portion subjected to heating, and the other vertical sections also comprising portions subjected to heating, thereby, at the end of the path, converting the polymer slurry into a two-phase, solid-gas stream comprising polymer particles and gaseous monomers;
(IV) adding the antistatic composition to the polymer slurry in the first portion not subjected to heating of the first section of the series of vertical sections; and
(V) separating the two-phase, solid-gas stream.

2. The process according to claim 1, wherein the first portion not subjected to heating of the first section of the series of vertical sections is shorter than the second portion subjected to heating of the first section of the series of vertical sections.

3. The process according to claim 1, wherein the first portion not subjected to heating of the first section of the series of vertical sections is equal to or less than ⅓ of the length of the second portion subjected to heating of the first vertical section.

4. The process according to claim 1, wherein the polymer particles, separated in the solid-gas separation step, are fed to a gas-phase polymerization step.

5. The process according to claim 1, wherein the step of polymerizing an olefin in the liquid phase is carried out in two loop reactors in series.

6. The process according to claim 1, wherein the compound (a) of formula R—OH is water.

7. The process according to claim 1, wherein the oligomeric or polymeric organic compound (b) is selected from the group consisting of alcohols, polyethers, polyalcohols, hydroxyesters of polyalcohols, polyglycol ethers, polyglycol esters and derivatives thereof.

8. The process according to claim 1, wherein the oligomeric or polymeric organic compound (b) is an alkylene-oxide-derived polymer comprising on average from 10 to 200 repeating units —(CH2-CHR—O)—, with R being hydrogen or an alkyl group having from 1 to 6 carbon atoms.

9. A plant for preparing polyolefins comprising:
a slurry polymerization reactor,
a transfer line for the polymer slurry formed in the reactor,
an apparatus for mixing and injecting an antistatic composition in the transfer line, and
a solid-gas separation apparatus connected to the transfer line at the end thereof;
wherein the transfer line comprises a pipe comprising a horizontal section and a series of vertical sections connected by bent sections, with the first section of the vertical sections comprising a first portion not equipped for heating and a second portion equipped for heating, and the other vertical sections also comprising portions equipped for heating;
wherein the antistatic composition is injected into the first portion not equipped for heating of the first section of the series of vertical sections.

10. The plant according to claim 9, wherein the first portion not equipped for heating of the first section of the series of vertical sections is shorter than the second portion equipped for heating of the first section of the series of vertical sections.

11. The plant according to claim 9, wherein the first portion not equipped for heating of the first section of the series of vertical sections is equal to or less than ⅓ of the length of the second portion equipped for heating of the first vertical section.

12. The plant according to claim 9, wherein the antistatic composition is injected into the first portion not equipped for heating of the first section of the series of vertical sections by an apparatus in which the components of the composition are mixed.

13. The plant according to claim 9, wherein the apparatus is a static mixer in which the energy for mixing comes from a loss in pressure as the antistatic composition flows through the static mixer.

14. The plant according to claim 9, wherein the polymer particles, separated in the solid-gas separation apparatus step, are fed to a gas-phase polymerization reactor.

15. The plant according to claim 9, wherein a second slurry polymerization reactor is connected in series downstream the slurry polymerization reactor and upstream said transfer line.
